(19) United States
(12) Patent Application Publication
(10) Pub. No.: US 2024/0386281 A1
(43) Pub. Date: Nov. 21, 2024

(54) CONTROLLING AGENTS BY TRANSFERRING SUCCESSOR FEATURES TO NEW TASKS

(71) Applicant: DeepMind Technologies Limited, London (GB)

(72) Inventors: Daniel Zoran, London (GB); Wilka Torrico Carvahlo, Ann Arbor, MI (US); Angelos Filos, London (GB); Danilo Jimenez Rezende, London (GB)

(21) Appl. No.: 18/668,080

(22) Filed: May 17, 2024

Related U.S. Application Data
(60) Provisional application No. 63/467,298, filed on May 17, 2023.

(51) Int. Cl. G06N 3/096

(52) U.S. Cl. CPC G06N 3/096

(57) ABSTRACT

Methods, systems, and apparatus, including computer programs encoded on a computer storage medium. for controlling agents by transferring successor features to new tasks.

### CROSS-REFERENCE TO RELATED APPLICATION

This application claims priority to U.S. Provisional Application No. 63/467,298, filed on May 17, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that uses successor features from training tasks to (i) control an agent interacting with an environment to perform a new task in the environment or (ii) assist an agent interacting with an environment to perform a new task in the environment.

Particular embodiments of the subject matter described in this specification can be implemented so as to realize one or more of the following advantages.

In many circumstances, collecting training data for a new task, e.g., for learning a policy for controlling an agent to perform the task using reinforcement learning (RL), is expensive in terms of time and computational resources. For example, consider a household robot that learns tasks for interacting with objects such as finding and moving them around. When this robot is deployed to a house and needs to perform combinations of these tasks, collecting data for RL training of policies for these new tasks will be expensive and can damage the robot, the house, or both.

By employing the techniques described in this specification, a system can instead transfer knowledge from already learned tasks (“training tasks”) to efficiently learn new tasks with minimal additional environment interaction. Minimizing the amount of environment interaction required to learn a new task therefore significantly reduces the amount of computational resources required to learn the new task and significantly reduces wear and tear on the agent and the risk of damage to the agent or to the environment.

In particular, this specification describes how to leverage successor features for training tasks in order to implement a new policy for selecting actions for a new task. This allows the system to effectively control an agent to perform the new task with minimal additional interaction with the environment.

Moreover, because the successor feature neural network that generates the successor features is shared across training tasks, parameter count and system complexity does not scale with the number of tasks and allows the described techniques to be efficiently implemented with large numbers of complex, real-world training tasks, improving the quality of transfer to new tasks.

Additionally, this specification describes techniques for effectively training the successor feature neural network jointly with task encoder and observation encoder neural networks, removing the need for hand-designed representation and allowing the system to be applied to a wide variety of different training tasks and new tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for selecting an action aₜ a given time step.

FIG. 3 shows an example of the operation of the system at a current time step when performing a new task.

FIG. 4 shows an example of the architecture of the successor feature neural network.

FIG. 5 is a diagram that shows an example of the operation of the system during training of the successor feature neural network.

FIG. 6 shows an example of the performance of the described techniques.

Like reference numbers and designations in the various drawings indicate like elements.

### DETAILED DESCRIPTION

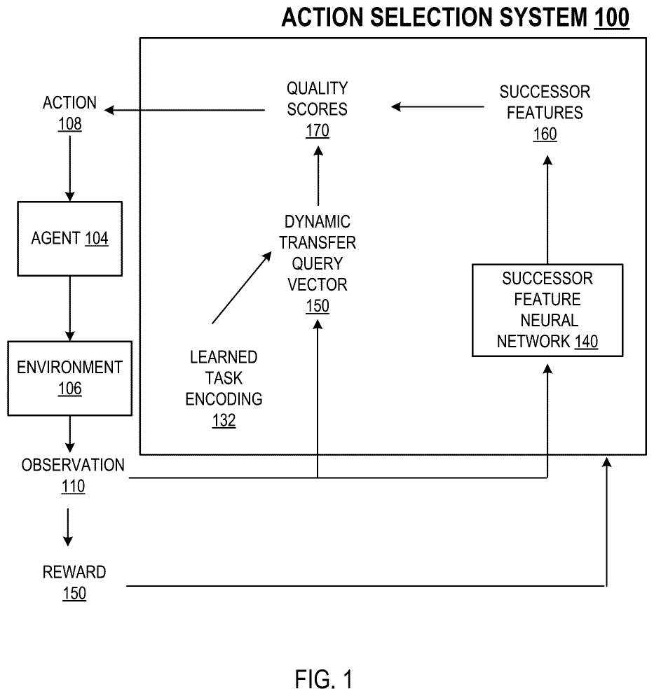

FIG. 1 shows an example action selection system 100. The action selection system 100 is an example of a system implemented as computer programs on one or more computers in one or more locations in which the systems, components, and techniques described below are implemented.

The action selection system 100 uses a successor feature neural network 140 to (i) control an agent 104 interacting with an environment 106 to perform a task in the environment 106 or (ii) assist an agent 104 interacting with an environment 106 to perform a task in the environment 106. For example, the agent 104 can be a robot, e.g., a robotic arm, a quadruped robot, a humanoid robot, or other type of robot that is controllable by the system 100.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

In some cases, the system 100 receives an extrinsic reward 152 (also referred to as a “task” reward) from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

In some cases, the reward can be generated by a reward model. As one example of this, the reward model may be learned using a success detector that detects successful behavior from observations of the environment, e.g., as described in “Vision-Language Models as Success Detectors” arXiv:2303.07280.

More specifically, when controlling the agent 104 to perform a given new task, the system uses a learned task encoding 130 of the new task and the successor feature neural network 140.

The learned task encoding 130 is a vector of numerical values that represents the new task. The “learned” task encoding 130 is referred to as “learned” because the encoding 130 is the output of a neural network that is trained by the system 100.

Generating the learned task encoding 130 is described in more detail below.

In particular, to control the agent 104 at a given time step, the system 100 generates, from the observation 110 at the time step and the learned task encoding 130, a dynamic transfer query vector 150 for the new task for the time step. The transfer query vector 150 is referred to as “dynamic” because the query vector 150 depends not only the learned task encoding 130 (which may be static after training has completed) but also on the observation 110, which can be different at every time step.

The system 100 also generates, from the observation 110 and for each of a set of training tasks, respective successor features 160 for each of a set of candidate actions that can be performed by the agent 104 in response to the observation 110 using the successor feature neural network 140.

That is, for a given training task, the system 100 generates respective successor features 160 for each action in the candidate set of actions that can be performed by the agent 104.

The training tasks are a set of multiple tasks in the environment that have been used to train the successor feature neural network 140.

As will be described in more detail below, the successor features 160 for a given training task and a given action are a prediction of the output of a value function that measures the time-discounted sum of future state-features (also referred to as “cumulant” features) for the training task that will be received if the given action is performed in response to the observation 110.

The cumulant features for a given time step and a given action are descriptions of a state-transition that will occur if the action is performed at the given time step. More specifically, the cumulant features for a given training task are computed so that an inner product between the cumulant features and a training task encoding for the given training task is an estimate of the extrinsic reward that will be received for the given training task if the action is performed at the time step.

For each candidate action and each training task, the system determines, from the dynamic transfer query vector 150 for the current time step and the successor features 160, a quality score 170 for the candidate action and for the training task.

Generally, the system determines the quality score 170 based on a similarity between (i) the successor features 160 for the candidate action for the training task and (ii) the dynamic transfer query vector 150 for the current time step.

The system selects an action 108 from the candidate set using the respective quality scores for the candidate actions for the training tasks.

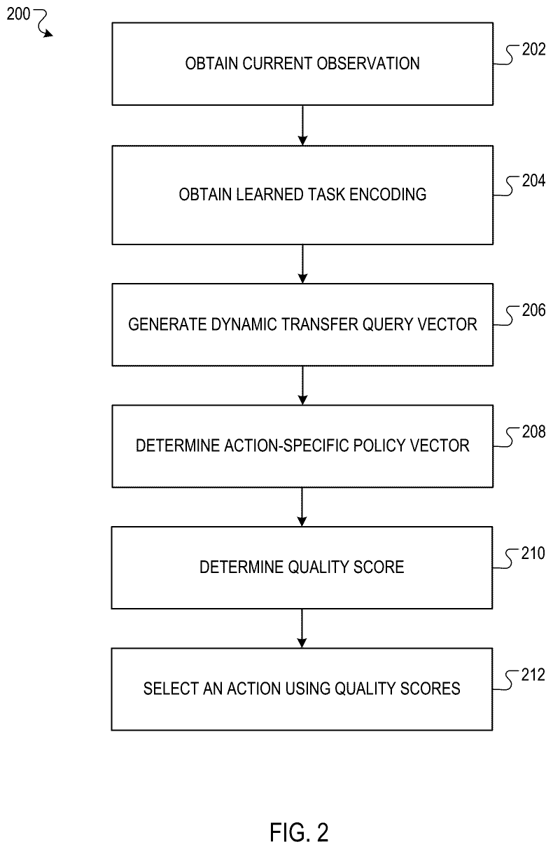

Generating the query vector and the successor features and selecting the action will be described in more detail below with reference to FIGS. 2-5.

Examples of environments, actions, and agents that the system can control will be described in more detail below.

When the system 100 is assisting the agent 104, the system 100 provides, to the agent 108, information about how to perform the task that is generated using at least the selected action 108. For example, the system 100 can use a generative neural network to map the selected action to a natural language output, a speech output, an image output, or a video output, and provide the output for presentation to the agent 104.

For example, the agent that is assisted can be a human. For example, assisting the agent, i.e., the human, can include communicating with a human user of a digital assistant (also referred to as a virtual assistant) such as a smart speaker or display, mobile, or other device, that implements the method.

In more detail, in some implementations the agent comprises a human user of a digital assistant such as a smart speaker, smart display, or other device. Then, information defining the task can be obtained from the digital assistant, and the digital assistant can be used to provide information to the user based on the latent vector. For example, this may comprise receiving, at the digital assistant, a request from the user for assistance and determining, in response to the request, one or more tasks for the user to perform, e.g., steps or sub-tasks of an overall task. Then for one or more tasks of the series of tasks, e.g., for each task, e.g., until a final task of the series the digital assistant can be used to output to the user information indicating how to perform the task. This may be done using natural language, e.g., on a display and/or using a speech synthesis subsystem of the digital assistant. Visual, e.g., video, and/or audio observations of the user performing the task may be captured, e.g., using the digital assistant.

As an illustrative example a user may be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses a system as described above, in particular by providing it with the captured audio and/or video to determine how the user should complete each step.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem can capture, using the observation capture subsystem, visual or audio observations of the user performing the task, determine how to perform the task, and provide information about how to perform the task.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example, in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example, a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general, the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example, in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example, rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus, a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally, in the case of a simulated environment the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally, the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2 is a flow diagram of an example process 200 for controlling the agent at a given time step during a task episode of a new task. For convenience, the process 200 will be described as being performed by a system of one or more computers located in one or more locations. For example, an action selection system, e.g., the action selection system 100 of FIG. 1, appropriately programmed in accordance with this specification, can perform the process 200.

For example, the system can perform the process 200 at each time step in the task episode when the agent performs the new task. The task is referred to as a “new” task because it is a different task than the set of training tasks described above. That is, the system has already trained on a set of training tasks and is now performing a new task that is different from the set of training tasks.

The system obtains a current observation characterizing a current state of the environment at the time step (step 202).

The system obtains a learned task encoding of the new task (step 204). The learned task encoding of the new task is a vector describing features associated with the new task.

Generally, the system generates the learned task encoding of the new task by processing data characterizing the new task using a task encoding neural network.

In some implementations, the system pre-computes the learned task encoding prior to performing the task episode and uses the same learned task encoding for the entire task episode. For example, the system can compute the learned task encoding after training of the new task has finished and then re-use the learned task encoding for all subsequent task episodes.

In some other implementations, the system re-computes the learned task encoding at some or all of the time steps during the task episode.

The data characterizing the new task can be any of a variety of information that describes the new task. As one example, the data can include a sequence of text, e.g., natural language text, describing the new task. As another example, the data can include an observation, e.g., an image, characterizing a goal state for the new task. A goal state for a task is a state in which the task has been successfully completed.

The task encoding neural network can have any of a variety of neural network architectures and can depend on the type of data that characterizes the new task. For example, the task encoder can be a multi-layer perceptron (MLP), a Transformer neural network, or a convolutional neural network.

The system generates, from the current observation and the learned task encoding for the new task, a dynamic transfer query vector for the current time step (step 206). The dynamic transfer query vector is also referred to as a “policy vector” for the new task for the current time step.

Determining the dynamic transfer query vector is described in more detail below.

The system performs steps 208 and 210 for each training task and for each action in a candidate set of actions. For example, when the set of actions that can be performed by the agent is discrete, the candidate set can include all of the actions in the discrete set. When the set of actions that can be performed is continuous, the candidate set can include a fixed number of actions sampled from the continuous set.

The system determines, from the current observation, an action-specific policy vector for the candidate action for the training task given the current state of the environment at the time step (step 208).

The action-specific policy vector generally includes successor features for the candidate action and for the training task.

As a particular example, the system can generate the successor features for a candidate action and for the training task by generating, from the current observation and the candidate action, an input to a successor feature neural network and processing the input using the successor feature neural network to generate the successor features.

In some implementations, the successor feature neural network is shared across tasks. In these implementations, the input to the successor feature neural network also includes a training task encoding for the training task.

For example, the system can have generated the training task encoding by processing data characterizing the training task using a training task encoder neural network.

Generally, the successor feature neural network and the training task encoder neural network have been pre-trained, i.e., prior to beginning to perform the new task. This training is described in more detail below.

The system determines, from the dynamic transfer query vector for the current time step and the action-specific policy vector, a quality score for the candidate action and for the training task (step 210). Generally, the quality score for a given action is an estimate of the return that will be received at future time steps if the agent performs the given action aₜ the time step.

More specifically, the system determines the quality score based on a similarity between (i) the action-specific policy vector for the candidate action for the training task and (ii) the dynamic transfer query vector for the current time step.

For example, the system can determine the quality score by computing an inner product between (i) the action-specific policy vector for the candidate action for the training task and (ii) the dynamic transfer query vector for the current time step.

The system selects an action from the candidate set using the respective quality scores for the candidate actions for the training tasks (step 212). For example, the system can select the candidate action having the highest quality score among all of the candidate actions and all of the training tasks. That is, the system can identify the highest quality score among all of the quality scores for all of the candidate actions and all of the training tasks and then select the candidate action corresponding to the identified highest quality score.

When controlling the agent, the system causes the agent to perform the selected action.

When the system does not control the agent, the system can provide, to the agent, information about how to perform the task that is generated using at least the selected action.

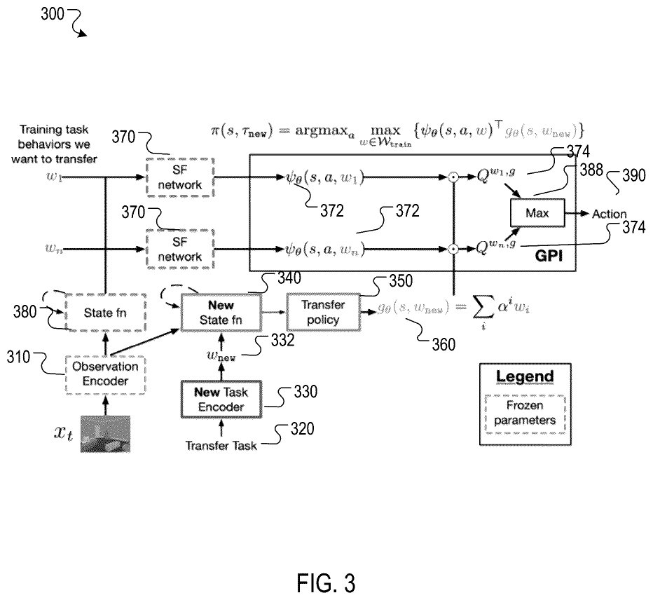

FIG. 3 shows an example 300 of the operation of the system at a current time step t when performing a new task (“transfer task”).

As shown in the example 300, the system receives a current observation xₜ at the current time step t. The system processes the current observation xₜ using an observation encoder neural network 310 to generate an encoded representation of the current observation.

The observation encoder neural network can have any of a variety of neural network architectures and can depend on the type of data in the observation. For example, the observation encoder can be a multi-layer perceptron (MLP), a Transformer neural network, or a convolutional neural network.

The system also processes data 320 characterizing the new task using a new task encoder neural network 330 to generate a learned task encoding w_{new} 332 of the new task.

The new task encoder neural network can have any of a variety of neural network architectures and can depend on the type of data characterizing the new task. For example, the new task encoder can be a multi-layer perceptron (MLP), a Transformer neural network, or a convolutional neural network.

The system then processes the encoded representation of the current observation and the learned task encoding 332 of the new task using a new task state representation neural network 340 to generate a new state vector that represents a state of the new task as of the current time step.

The new task state representation neural network can have any of a variety of neural network architectures. For example, the new task state representation encoder can be a recurrent neural network, e.g., a long short-term memory (LSTM) neural network or a Transformer neural network so that the new state vector incorporates context from previous time steps.

The system then processes the new state vector using a policy neural network 350 to generate a dynamic transfer query 360 g_{θ}(s_{new}, w_{new}) for the new task for the current time step.

The policy neural network can have any of a variety of neural network architectures. For example, the policy neural network can be an MLP or a Transformer neural network.

In some implementations, the policy neural network 350 directly regresses the dynamic transfer query 360.

In some other implementations and, as shown in the example of FIG. 3, the dynamic transfer query vector 360 is a linear combination of respective training task encodings wᵢ of each of the plurality of training tasks.

In this example, the system processes the new state vector using the policy neural network 350 to generate an output defining a linear combination of respective training task encodings of each of the plurality of training tasks.

The system can then sample, using the output, respective coefficients a for each of the respective training task encodings w.

The system then computes a weighted sum of the respective training task encodings in an accordance with the sampled coefficients to generate the dynamic transfer query vector.

Additionally, for each candidate action a and for each training task 1 through n, the system uses a successor feature neural network 370 to generate successor features for the candidate action a and the training task.

In particular, the system processes the encoded representation of the current observation using a training task state representation neural network 380 to generate a training state representation.

The training task state representation neural network can have any of a variety of neural network architectures. For example, the training task state representation encoder can be a recurrent neural network, e.g., a long short-term memory (LSTM) neural network or a Transformer neural network so that the new state vector incorporates context from previous time steps.

For each candidate action a and for any given training task i, the system processes an input that includes the training state representation sₜᵣₐᵢₙ, a learned task encoding wᵢ for the given training task, and the candidate action a using the successor feature neural network 370 to generate successor features 372 ψ_{θ}(sₜᵣₐᵢₙ, a, wᵢ) for the candidate action a and the given training task i.

The successor feature neural network can generally have any of a variety of neural network architectures, e.g., can be an MLP or a Transformer neural network. A specific example of the architecture of the neural network is described below.

The system then generates a respective quality score 374 for each candidate action a and each training task.

For each candidate action a and for any given training task i, the system generates the quality score Q^{w}^{ᵢ}^{,g} by computing an inner product between the dynamic transfer query 360 g_{θ}(s_{new}, w_{new}) and the successor features 372 ψ_{θ}(sₜᵣₐᵢₙ, a, wᵢ) for the candidate action a and the given training task i.

The system then selects an action 390 by identifying the maximum quality score 388 among all of the quality scores 374 and then selecting, as the action 390, the action corresponding to the maximum quality score.

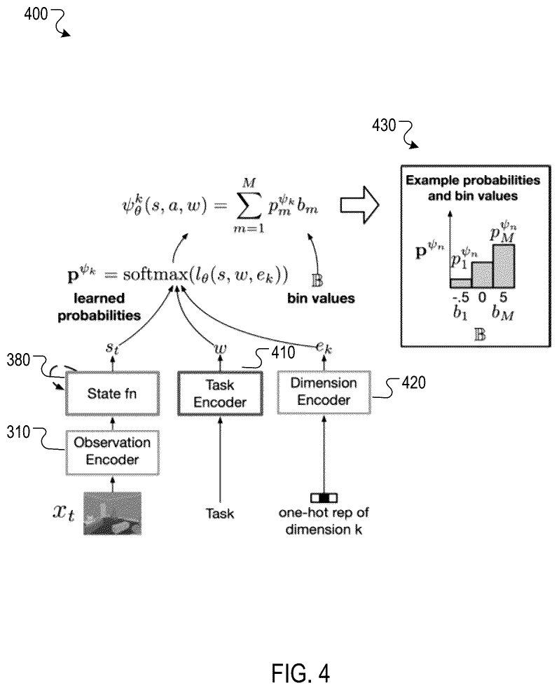

FIG. 4 shows an example 400 of the architecture of the successor feature neural network.

In the example 400, the successor feature neural network models each successor feature, i.e., each dimension of the vector of successor features, as a probability mass function over a discretized range of continuous values.

That is, the system discretizes the range of continuous values into a set of bins, each bin having a respective bin value, e.g., the center of the range of values represented by the bin.

To generate the value of a given dimension k of the successor features vector for a given candidate action a and a given training task i, the system processes an input that includes the training state representation sₜᵣₐᵢₙ, the preference vector wᵢ for the given training task generated by a training task encoder, the candidate action a, and a one-hot representation of the given dimension k using the successor feature neural network to generate a learned probability distribution over the set of bins.

In this example, the successor feature neural network includes a dimension encoder neural network 420 that encodes the one-hot representation of the given dimension k and a subnetwork l that processes the encoded representation of the given dimension, the candidate action a, the training state representation sₜᵣₐᵢₙ, and the preference vector wᵢ for the given training task to generate the learned probability distribution.

The system then computes the value of the given dimension k of the successor feature vector, i.e., ψ_{θ}^{k}(sₜᵣₐᵢₙ, a, wᵢ) as a weighted sum of the bin values, weighted by the corresponding learned probabilities, i.e., ψ_{θ}^{k}(sₜᵣₐᵢₙ, a, wᵢ)=Σₘ₌₁^{M}pₘ^{ψ}^{ₖ}bₘ, where pₘ^{ψ}^{ₖ} is the learned probability for the m-th bin and bₘ is the bin value for the m-th bin, and M is the total number of bins.

As a simplified example, FIG. 4 shows an example 430 of the output of the successor feature neural network for a dimension that has three bins, one with a bin value of −0.5, another with a bin value of 0, and a third with a bin value of 0.5. As shown in the example 430, the successor feature neural network outputs a respective probability for each of the three bins, and the system can then compute the value of the given dimension by computing a weighted sum.

Modeling successor features in this way can significantly improve the stability of the training of the successor feature neural network, e.g., as opposed to modeling successor features by regressing a point-wise estimate of the successor features. That is, because, during training, the targets are non-stationary, point-estimates may cause significant instability during training, while the described approach alleviates the impact of this non-stationarity on the stability of the training.

As described above, the system pre-trains the successor feature neural network, the training task encoder neural network, the observation encoder neural network, and, when used, the training state representation neural network on the set of training tasks.

When the system needs to control the agent to perform a new task, the system can train only the new task encoder neural network, the new state representation neural network, and the policy neural network.

For example, the system can perform this training in a computationally efficient manner, i.e., using limited training data, using any appropriate reinforcement learning technique using rewards for the new task that are received from the environment. Examples of such techniques include policy improvement techniques and Q-learning techniques. Because the system leverages the successor features to control the agent, this training can generally be accomplished with limited environment interaction. That is, because the successor features for the training tasks are already learned, the system can bootstrap from these learned successor features in order to achieve improved agent control in relatively few training iterations, thereby requiring very limited training data (and environment interactions) before the agent achieves good performance on the new tasks.

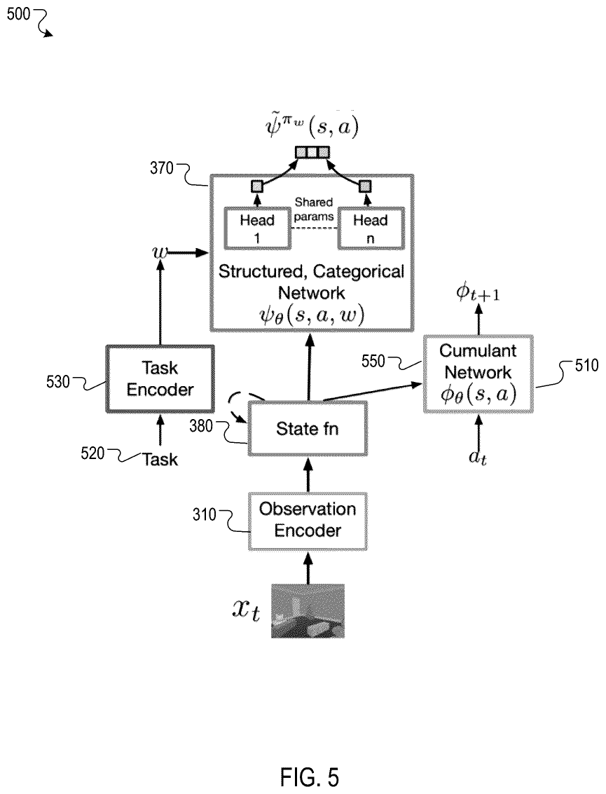

FIG. 5 is a diagram that shows an example 500 of the operation of the system during training of the successor feature neural network. In particular, the system shows the operations performing when training on a tuple that includes an observation xₜ at a time step t in an episode of a training task, the action aₜ performed at the time step, observation xₜ₊₁ at a time step t+1 and the reward rₜ₊₁ received in response to the action being performed.

As shown in the example 500, the system receives a current observation xₜ at a current time step t that corresponds to one of the training tasks.

The system processes the current observation xₜ using the observation encoder neural network 310 to generate an encoded representation of the current observation.

The system also processes data 520 characterizing the training task using a training task encoder neural network 530 to generate a training task encoding w 332 of the training task.

The system processes the encoded representation of the current observation using the training task state representation neural network 380 to generate a training state vector that represents a state of the training task as of the current time step.

The system processes an input that includes the training state vector and the training task encoding using the successor feature neural network 370 to generate successor features for the training task for the current time step.

In some implementations, rather than directly using the output of the training task encoding neural network as the training task encoding, the system can normalize the output to lie on the unit sphere, i.e., by dividing each element of the training task encoding by the norm of the training task encoding, and then use the normalized output as the training task encoding.

The system also processes an input that includes the training state vector and the action aₜ performed at the time step t using a cumulant neural network 550 to generate cumulant features ϕₜ₊₁ for time step t+1.

The system then trains the successor feature neural network, the cumulant neural network 550, the training task state representation neural network 380, and the observation encoder neural network based on the cumulant feature and the outputs of the successor feature neural network.

For example, the system can compute a cumulant feature loss as the squared error between (i) an inner product between the training task encoding and the cumulant features and (ii) the reward received in response to the agent performing the action aₜ the time step.

As another example, the system can compute a Q-target and a SF-target and use these targets to evaluate respective losses for training the successor feature neural network.

For example, the system can compute the Q-target as follows:

$${y}_{t}^{Q} = {r}_{t + 1} + {{γψ}_{θ} ( {s}_{t + 1} , {a}^{*} , w )}^{T} w$$

The system can also compute the SF-target as:

$${y}_{t}^{{ψ}_{k}} = {ϕ}_{t + 1} + {{γψ}_{θ} ( {s}_{t + 1} , {a}^{*} , w )}^{T}$$

In both targets, sₜ₊₁ is the state representation generated from xₜ₊₁ and a* can be the action with the highest quality score, i.e., determined based on an inner product as described above, for the observation xₜ₊₁:

The system can then compute a Q-value loss as a squared error between (i) a Q value for the action aₜ computed using the successor features and (ii) the Q-target. That is, the Q value is ψ_{θ}(sₜ, aₜ, w)^{T}w.

The system can also compute, for each dimension of the successor features, a successor feature loss as a categorical cross-entropy loss between (i) the probabilities assigned to the bins for the dimension and (ii) a two-hot encoding of the value of the SF target for the dimension.

In some implementations, the overall loss function can be a weighed sum between the successor feature loss, the Q-value loss, and the cumulant feature loss.

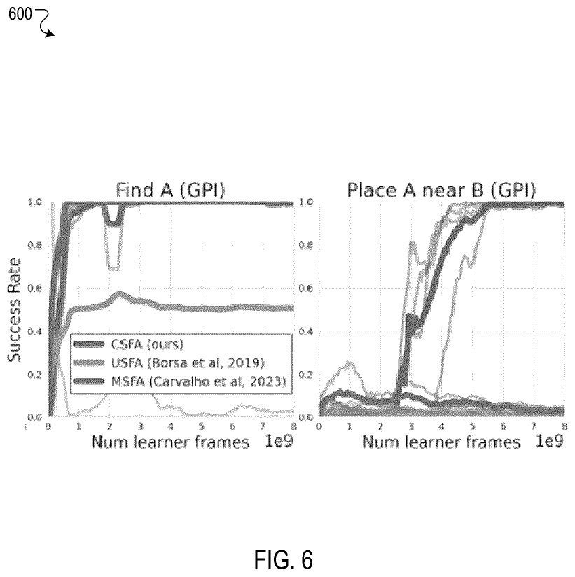

FIG. 6 shows an example 600 of the performance of the described techniques relative to existing approaches on two different tasks. In particular, the example 600 shows the performance of each technique in terms of success rate, i.e., the rate at which the corresponding task is successfully completed, at a variety of learner frames.

In particular, FIG. 6 shows the performance of the described techniques (“CSFA (ours)”) relative to the USFA and MSFA techniques. The two tasks include a short-horizon “Find A” task that requires finding an object in an environment and a long-horizon “Place A near B” task that requires placing one object near another object.

As can be seen from FIG. 6, the described techniques are able to consistently solve the long-horizon task when the other techniques cannot while also achieving high quality performance on the short-horizon task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

What is claimed is:

1. A method performed by one or more computers and for controlling an agent interacting with an environment to perform a task episode of a new task, the method comprising, at each of a plurality of current time steps in the task episode of the new task:
obtaining an observation characterizing a current state of the environment at the time step;
obtaining a learned task encoding of the new task;
generating, from the current observation and the learned task encoding for the new task, a dynamic transfer query vector for the current time step;
for each of a plurality of training tasks and for each action in a candidate set of actions:
determining, from the current observation, an action-specific policy vector for the candidate action for the training task given the current state of the environment at the time step; and
determining, based on a similarity between the dynamic transfer query vector for the current time step and the action-specific policy vector, a quality score for the candidate action and for the training task; and
selecting an action from the candidate set using the respective quality scores for the candidate actions for the training tasks.

2. The method of claim 1, further comprising:
generating the learned task encoding of the new task for the current time step using a task encoding neural network.

3. The method of claim 2, wherein generating the learned task encoding of the new task comprises processing data characterizing the new task using the task encoding neural network to generate a vector describing features associated with the new task.

4. The method of claim 3, wherein the data characterizing the new task comprises at last one of text describing the new task or an observation characterizing a goal state for the new task.

5. The method of claim 1, wherein selecting an action to be performed by the agent based on the respective quality scores for the candidate actions for the plurality of training tasks comprises:
identifying a candidate action that has a highest quality score; and
selecting the identified action.

6. The method of claim 1, wherein determining, based on a similarity between the dynamic transfer query vector for the current time step and the action-specific policy vector, a quality score for the candidate action and for the training task comprises:
computing an inner product between (i) the action-specific policy vector for the candidate action for the training task and (ii) the dynamic transfer query vector.

7. The method of claim 1, wherein generating, from the current observation and the learned task encoding for the new task, a dynamic transfer query vector for the current time step comprises:
processing the encoded representation of the observation and the learned task encoding of the new task using a new task state representation neural network to generate a new state vector that represents a state of the new task as of the current time step; and
generating, from the new state vector, the dynamic transfer query vector for the current time step.

8. The method of claim 1, wherein the dynamic transfer query vector is a linear combination of respective training task encodings of each of the plurality of training tasks.

9. The method of claim 1, wherein generating, from the new state vector, the dynamic transfer query vector comprises:
processing the new state vector using a multilayer perceptron neural network to generate an output defining a linear combination of respective training task encodings of each of the plurality of training tasks.

10. The method of claim 9, wherein generating the dynamic transfer query vector further comprises:
sampling, using the output, coefficients for the respective training task encodings; and
computing a weighted sum of the respective training task encodings in an accordance with the sampled coefficients to generate the dynamic transfer query vector.

11. The method of claim 1, wherein generating an action-specific policy vector for the candidate action for the training task comprises:
processing (i) the candidate action and (ii) the encoded representation of the observation using a successor feature neural network to generate successor features for the training task and associated with the candidate action; and
generating an action-specific policy vector comprising the successor features.

12. The method of claim 11, wherein the successor feature is modelled as a probability mass function over a discretized range of continuous values.

13. The method of claim 11, wherein the successor feature is a value function representation of a discounted sum of future state features associated with the candidate action.

14. The method of claim 11, wherein the successor feature neural network is pre-trained on the plurality of training tasks.

15. The method of claim 14, the method further comprising jointly training the task encoder neural network and the state feature neural network to optimize an objective function that includes a regression loss term.

16. The method of claim 14, the method further comprising:
generating a quality score estimate for the training task using the value function representation; and
training the successor feature neural network to maximize future quality score estimates.

17. The method of claim 11, wherein the successor feature neural network is shared across the training tasks and wherein processing (i) the candidate action and (ii) the encoded representation of the observation using a successor feature prediction neural network to generate a successor feature associated with the candidate action comprises:
processing (i) the candidate action (ii) the encoded representation of the observation and (iii) a task encoding of the training task using a successor feature prediction neural network to generate a successor feature associated with the candidate action.

18. The method of claim 1, wherein the agent is a mechanical agent and the environment is a real-world environment.

19. The method of claim 18, wherein the agent is a robot.

20. The method of claim 1, wherein the training tasks are learned in a simulated environment and the new task is performed in a real-world environment.

21. A system comprising one or more computers and one or more storage devices storing instruction that when executed by the one or more computers cause the one or more computers to perform operations for controlling an agent interacting with an environment to perform a task episode of a new task, the method comprising, at each of a plurality of current time steps in the task episode of the new task:
obtaining an observation characterizing a current state of the environment at the time step;
obtaining a learned task encoding of the new task;
generating, from the current observation and the learned task encoding for the new task, a dynamic transfer query vector for the current time step;
for each of a plurality of training tasks and for each action in a candidate set of actions:
determining, from the current observation, an action-specific policy vector for the candidate action for the training task given the current state of the environment at the time step; and
determining, based on a similarity between the dynamic transfer query vector for the current time step and the action-specific policy vector, a quality score for the candidate action and for the training task; and
selecting an action from the candidate set using the respective quality scores for the candidate actions for the training tasks.

22. One or more non-transitory computer storage media storing instruction that when executed by one or more computers cause the one or more computers to perform operations for controlling an agent interacting with an environment to perform a task episode of a new task, the method comprising, at each of a plurality of current time steps in the task episode of the new task:
obtaining an observation characterizing a current state of the environment at the time step;
obtaining a learned task encoding of the new task;
generating, from the current observation and the learned task encoding for the new task, a dynamic transfer query vector for the current time step;
for each of a plurality of training tasks and for each action in a candidate set of actions:
determining, from the current observation, an action-specific policy vector for the candidate action for the training task given the current state of the environment at the time step; and
determining, based on a similarity between the dynamic transfer query vector for the current time step and the action-specific policy vector, a quality score for the candidate action and for the training task; and
selecting an action from the candidate set using the respective quality scores for the candidate actions for the training tasks.
